(19) United States
(12) Patent Application Publication
(10) Pub. No.: US 2012/0187999 A1
(43) Pub. Date: Jul. 26, 2012

(54) INTERPOLATION CIRCUIT

(75) Inventor: Ming-Chieh Lin, Hsinchu County (TW)

(73) Assignee: NOVATEK MICROELECTRONICS CORP., Hsinchu (TW)

(21) Appl. No.: 13/044,566

(22) Filed: Mar. 10, 2011

(30) Foreign Application Priority Data
Jan. 26, 2011 (TW) 100102954

(51) Int. Cl. G06G 7/12

(52) U.S. Cl. 327/355

(57) ABSTRACT

An interpolation circuit adapted to receive a plurality of inputs is provided. The inputs include a first input group and a second input group. The interpolation circuit includes a first selecting channel, a second selecting channel, and an interpolation unit. The first selecting channel receives the first input group and outputs a first input of the first input group according to a selecting signal. The second selecting channel receives the second input group and the first input and outputs a second input of the second input group according to the selecting signal. The first selecting channel and the second selecting channel respectively output the first input or the second input. The interpolation unit is coupled to the first selecting channel and the second selecting channel, and receives the first input and the second input, and accordingly performs an interpolation to output an interpolation result.

### CROSS-REFERENCE TO RELATED APPLICATION

This application claims the priority benefit of Taiwan application serial no. 100102954, filed Jan. 26, 2011. The entirety of the above-mentioned patent application is hereby incorporated by reference herein and made a part of this specification.

### BACKGROUND

1. Field of the Invention

The invention relates to an operation circuit. Particularly, the invention relates to an interpolation circuit.

2. Description of Related Art

Generally, in a conventional circuit, conversion of value to value is implemented by looking up a table, and when a table look-up result is a continuous function, an interpolation method is generally used to obtain the result in order to save a circuit size.

For example, FIG. 1 is a diagram illustrating a conventional interpolation circuit, and FIG. 2 is a diagram illustrating interpolation results obtained by using the interpolation circuit of FIG. 1. Referring to FIG. 1 and FIG. 2, in the conventional technique, it is assumed that numbers of inputs and outputs are respectively 256, and now a designer can use a look up table of 16 outputs to generate the other 240 outputs. For example, V₀ and V₁ are interpolated to obtain an interpolation a, and V₁ and V₂ are interpolated to obtain an interpolation b. In other words, in order to obtain the interpolation, two adjacent points are selected, where two (n−1)-to-1 multiplexers are used to select the two adjacent points, as that shown in FIG. 1.

However, in the conventional interpolation circuit, since a number of the used multiplexers is large, the circuit size is large, and due to complicate windings, it is difficult to achieve a simple circuit layout. Therefore, it is necessary to provide a simple and applicable interpolation circuit.

### SUMMARY OF THE INVENTION

The invention is directed to an interpolation circuit, which can reduce windings of multiplexers, and reduce difficulty of circuit layout, and improve a utilization method thereof.

The invention provides an interpolation circuit adapted to receive a plurality of inputs. The inputs include a first input group and a second input group. The interpolation circuit includes a first selecting channel, a second selecting channel and an interpolation unit. The first selecting channel receives the first input group and outputs a first input of the first input group according to a selecting signal. The second selecting channel receives the second input group and the first input, and outputs a second input of the second input group to the first selecting channel according to the selecting signal. The first selecting channel and the second selecting channel respectively output the first input or the second input according to the selecting signal. The interpolation unit is coupled to the first selecting channel and the second selecting channel, and receives the first input and the second input, and accordingly performs an interpolation operation to output an interpolation result.

In an embodiment of the invention, the first selecting channel includes a first multiplexer and a second multiplexer. The first multiplexer has a plurality of input terminals and an output terminal. The input terminals of the first multiplexer receive the first input group. The output terminal of the first multiplexer is coupled to the second selecting channel. The first multiplexer outputs the first input through the output terminal thereof according to the selecting signal. The second multiplexer has a first input terminal, a second input terminal and an output terminal. The first input terminal of the second multiplexer is coupled to the output terminal of the first multiplexer and receives the first input. The second input terminal of the second multiplexer is coupled to the second selecting channel and receives the second input. The output terminal of the second multiplexer is coupled to the interpolation unit. The second multiplexer selects to output the first input or the second input to the interpolation unit through the output terminal thereof according to the selecting signal.

In an embodiment of the invention, the second selecting channel includes a third multiplexer and a fourth multiplexer. The third multiplexer has a plurality of input terminals and an output terminal. The input terminals of the third multiplexer receive the second input group. The output terminal of the third multiplexer is coupled to the second input terminal of the second multiplexer. The third multiplexer outputs the second input through the output terminal thereof according to the selecting signal. The fourth multiplexer has a first input terminal, a second input terminal and an output terminal. The first input terminal of the fourth multiplexer is coupled to the output terminal of the first multiplexer and receives the first input. The second input terminal of the fourth multiplexer is coupled to the output terminal of the third multiplexer and receives the second input. The output terminal of the fourth multiplexer is coupled to the interpolation unit. The fourth multiplexer selects to output the first input or the second input to the interpolation unit through the output terminal thereof according to the selecting signal.

In an embodiment of the invention, the interpolation circuit receives N inputs. The first input group includes N/2 inputs of the N inputs, where N is an even number.

In an embodiment of the invention, the first input group includes (2n−1)^{th} inputs of the N inputs, where n is a positive integer smaller than or equal to N/2.

In an embodiment of the invention, the second input group includes N/2 inputs of the N inputs.

In an embodiment of the invention, the second input group includes 2n^{th} inputs of the N inputs.

In an embodiment of the invention, when the first selecting channel outputs the first input to the interpolation unit, the second selecting channel outputs the second input to the interpolation unit. When the first selecting channel outputs the second input to the interpolation unit, the second selecting channel outputs the first input to the interpolation unit.

According to the above descriptions, the embodiment of invention provides a simple and applicable interpolation circuit, which can reduce windings of the multiplexers, and reduce difficulty of the circuit layout, and improve a utilization method thereof.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating a conventional interpolation circuit.

FIG. 2 is a diagram illustrating interpolation results obtained by using the interpolation circuit of FIG. 1.

FIG. 3 is a diagram of an interpolation circuit according to an embodiment of the invention.

FIG. 4 is a diagram illustrating interpolation results obtained by using the interpolation circuit of FIG. 3.

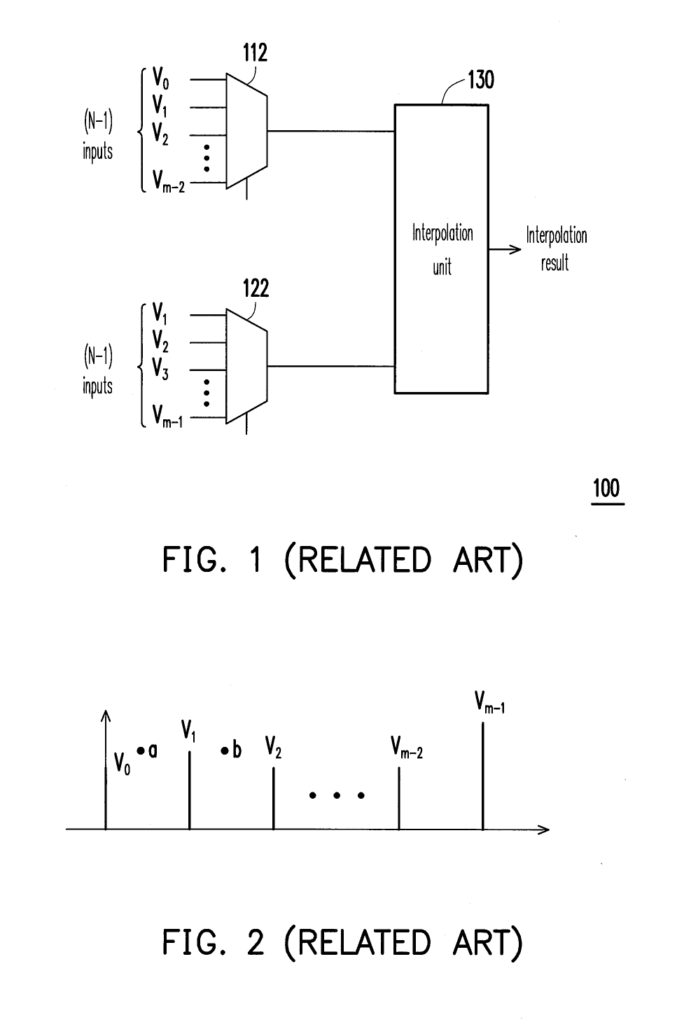

### DETAILED DESCRIPTION OF DISCLOSED EMBODIMENTS

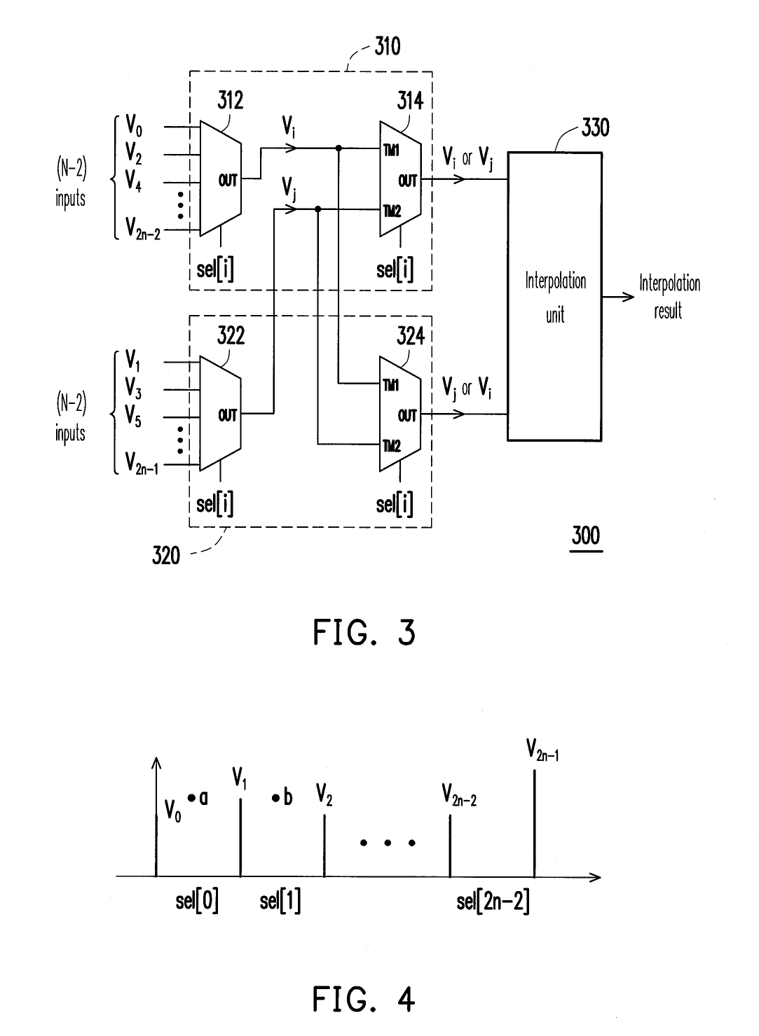

FIG. 3 is a diagram of an interpolation circuit according to an embodiment of the invention, and FIG. 4 is a diagram illustrating interpolation results obtained by using the interpolation circuit of FIG. 3. Referring to FIG. 3 and FIG. 4, in the present embodiment, the interpolation circuit 300 includes a first selecting channel 310, a second selecting channel 320 and an interpolation unit 330. The interpolation circuit 300 is adapted to receive a plurality of inputs and performs an interpolation to the inputs to output an interpolation result.

In the present embodiment, the interpolation circuit 300, for example, processes N inputs, and the first selecting channel 310 and the second selecting channel 320, for example, respectively receive N/2 inputs. Under such structure, compared to the conventional art, the interpolation circuit 300 of the present embodiment can effectively reduce windings of multiplexers, reduce difficulty of circuit layout, and improve a utilization method thereof.

In detail, the N inputs processed by the interpolation circuit 300 are, for example, divided into a first input group and a second input group. Here, the first input group, for example, includes inputs V₀, V₂, V₄, . . . , V₂ₙ₋₂, and the second input group, for example, includes inputs V₁, V₃, V₅, V₂ₙ₋₁. In the present embodiment, N is an even number, and n is a positive integer smaller than or equal to N/2. In other words, the first input group includes the odd inputs of the N inputs, and the second input group includes the even inputs of the N inputs.

In the present embodiment, the first selecting channel 310 receives the first input group V₀, V₂, V₄, . . . , V₂ₙ₋₂, and outputs a first input V₁ of the first input group to the second selecting channel 320 according to a selecting signal sel[i]. The second selecting channel 320 receives the second input group V₁, V₃, V₅, . . . , V₂ₙ₋₁, and outputs a second input Vⱼ of the second input group to the first selecting channel 310 according to the selecting signal sel[i]. Then, the first selecting channel 310 and the second selecting channel 320 respectively output the first input Vᵢ or the second input Vⱼ to the interpolation unit 330 according to the selecting signal sel[i]. Then, the interpolation unit 330 coupled to the first selecting channel 310 and the second selecting channel 320 receives the first input Vᵢ and the second input Vⱼ, and accordingly performs an interpolation operation to output an interpolation result.

In the present embodiment, when the first selecting channel 310 outputs the first input Vᵢ to the interpolation unit 330, the second selecting channel 320 outputs the second input Vⱼ to the interpolation unit 330. Comparatively, when the first selecting channel 310 outputs the second input Vⱼ to the interpolation unit 330, the second selecting channel 320 outputs the first input Vᵢ to the interpolation unit 330. In other words, the first selecting channel 310 and the second selecting channel 320 of the present embodiment do not simultaneously output the same input to the interpolation unit 330.

Further, in the present embodiment, the first selecting channel 310 includes a first multiplexer 312 and a second multiplexer 314. The first multiplexer 312 has a plurality of input terminals and an output terminal OUT. The input terminals of the first multiplexer 312 respectively receive the first input group V₀, V₂, V₄, V₂ₙ₋₂. The output terminal OUT of the first multiplexer 312 is coupled to the second selecting channel 320 and the second multiplexer 314. The first multiplexer 312 outputs the first input Vᵢ to the second selecting channel 320 and the second multiplexer 314 through the output terminal OUT according to the selecting signal sel[i].

The second multiplexer 314 has a first input terminal TM1, a second input terminal TM2 and an output terminal OUT. The first input terminal TM1 of the second multiplexer 320 is coupled to the output terminal OUT of the first multiplexer 312 and receives the first input Vᵢ. The second input terminal TM2 of the second multiplexer 314 is coupled to the second selecting channel 320 and receives the second input Vⱼ. The output terminal OUT of the second multiplexer 314 is coupled to the interpolation unit 330. The second multiplexer 314 selects to output the first input Vᵢ or the second input Vⱼ to the interpolation unit 330 through the output terminal OUT according to the selecting signal sel[i].

On the other hand, the second selecting channel 320 includes a third multiplexer 322 and a fourth multiplexer 324. The third multiplexer 322 has a plurality of input terminals and an output terminal OUT. The input terminals of the third multiplexer 322 respectively receive the second input group V₁, V₃, V₅, V₂ₙ₋₁. The output terminal OUT of the third multiplexer 322 is coupled to the second input terminal TM2 of the second multiplexer 314. The third multiplexer 322 outputs the second input Vⱼ to the second multiplexer 312 and the fourth multiplexer 324 through the output terminal OUT according to the selecting signal sel[i].

The fourth multiplexer 324 has a first input terminal TM1, a second input terminal TM2 and an output terminal OUT. The first input terminal TM1 of the fourth multiplexer 324 is coupled to the output terminal OUT of the first multiplexer 312 and receives the first input Vᵢ. The second input terminal TM2 of the fourth multiplexer 324 is coupled to the output terminal OUT of the third multiplexer 322 and receives the second input Vⱼ. The output terminal OUT of the fourth multiplexer 324 is coupled to the interpolation unit 330. The fourth multiplexer 324 selects to output the first input Vᵢ or the second input Vⱼ to the interpolation unit 330 through the output terminal OUT according to the selecting signal sel[i].

For example, V₀ and V₁ are interpolated to obtain an interpolation a. Now, V₀ is selected by the first multiplexer 312 when sel[0]=1, and V₀ is output to the second multiplexer 314 and the fourth multiplexer 324, and V₁ is selected by the third multiplexer 322 when sel[0]=1 or sel[1]=1, and V₁ is output to the second multiplexer 314 and the fourth multiplexer 324. Namely, the interpolation circuit 300 first determines selecting conditions of each point regardless whether the selected point is at the left side or the right side. Namely, V₀ is selected when sel[0]=1, V₁ is selected when sel[0]=1 or sel[1]=1, and V₂ is selected when sel[1]=1 or sel[2]=1.

Then, the interpolation circuit 300 determines whether the selected point is at the left side or the right side. Taking the interpolation a as an example, V₀ is a left side point of the interpolation a, and V₁ is a right side point of the interpolation a. Therefore, V₀ is selected as the left side point by the second multiplexer 314 when sel[0]=1, i.e. the second multiplexer 314 selects to output the first input Vᵢ to the interpolation unit 330. V₁ is selected as the right side point by the fourth multiplexer 324 when sel[0]=1, i.e. the fourth multiplexer 324 selects to output the first input Vⱼ to the interpolation unit 330. Then, the interpolation unit 330 receives the first input V₀ and the second input V₁, and performs the interpolation operation to output the interpolation a.

On the other hand, V₁ and V₂ are interpolated to obtain an interpolation b. Now, V₂ is selected by the first multiplexer 312 when sel[1]=1, and V₂ is output to the second multiplexer 314 and the fourth multiplexer 324, and V₁ is selected by the third multiplexer 322 when sel[1]=1 or sel[2]=1, and V₁ is output to the second multiplexer 314 and the fourth multiplexer 324.

Then, the interpolation circuit 300 determines that V₁ is a left side point of the interpolation b and V₂ is a right side point of the interpolation b. Therefore, V₁ is selected as the left side point by the second multiplexer 314 when sel[1]=1, i.e. the second multiplexer 314 selects to output the second input V₃ to the interpolation unit 330. V₂ is selected as the right side point by the fourth multiplexer 324 when sel[1]=1, i.e. the fourth multiplexer 324 selects to output the first input Vᵢ to the interpolation unit 330. Then, the interpolation unit 330 receives the second input V₁ and the first input V₂, and performs the interpolation operation to output the interpolation b.

In other words, the first multiplexer 312 outputs V₀ as the first input Vᵢ when sel[0]=1, outputs V₂ as the first input Vᵢ when sel[1]=1 or sel[2]=1, . . . , and outputs V₂ₙ₋₂ as the first input Vᵢ when sel[2n−3]=1 or sel[2n−2]=1. The second multiplexer 314 outputs the first input Vᵢ as the left side point of the interpolation when sel[0]=1, sel[2]=1, . . . , or sel[2n−2]=1, and outputs the second input Vⱼ as the left side point of the interpolation when sel[1]=1, sel[3]=1, . . . , or sel[2n−3]=1.

The third multiplexer 322 outputs V₁ as the second input Vⱼ when sel[0]=1 or sel[1]=1, . . . , outputs V₂ₙ₋₃ as the second input Vⱼ when sel[2n−3]=1 or sel[2n−2]=1, and outputs V₂ₙ₋₁ as the second input Vⱼ when sel[2n−2]=1. The fourth multiplexer 324 outputs the second input Vⱼ as the right side point of the interpolation when sel[0]=1, sel[2]=1, . . . , or sel[2n−2]=1, and outputs the first input Vᵢ as the right side point of the interpolation when sel[1]=1, sel[3]=1, . . . , or sel[2n−3]=1.

It should be noticed that in the present embodiment, the left side point and the right side point of the interpolation are only described with reference of the figure, which are not used to limit the invention. Moreover, the interpolation circuit of the present embodiment can be applied to a gamma circuit of an image processing device. The inputs processed by the interpolation circuit can be gray-level values, color values or brightness values, etc.

In summary, the interpolation circuit of the invention can effectively reduce windings of the multiplexers and avoid a large circuit size, so as to reduce difficulty of the circuit layout and improve a utilization method thereof.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An interpolation circuit, adapted to receive a plurality of inputs, wherein the inputs comprise a first input group and a second input group, the interpolation circuit comprising:
a first selecting channel receiving the first input group and outputting a first input of the first input group according to a selecting signal;
a second selecting channel receiving the second input group and the first input and outputting a second input of the second input group to the first selecting channel according to the selecting signal, wherein the first selecting channel and the second selecting channel respectively output the first input or the second input according to the selecting signal; and
an interpolation unit coupled to the first selecting channel and the second selecting channel, receiving the first input and the second input, and accordingly performing an interpolation operation to output an interpolation result.

2. The interpolation circuit as claimed in claim 1, wherein the first selecting channel comprises:
a first multiplexer having a plurality of input terminals and an output terminal, the input terminals of the first multiplexer receiving the first input group, and the output terminal of the first multiplexer being coupled to the second selecting channel, wherein the first multiplexer outputs the first input through the output terminal thereof according to the selecting signal; and
a second multiplexer having a first input terminal, a second input terminal and an output terminal, the first input terminal of the second multiplexer being coupled to the output terminal of the first multiplexer and receiving the first input, the second input terminal of the second multiplexer being coupled to the second selecting channel and receiving the second input, and the output terminal of the second multiplexer being coupled to the interpolation unit, wherein the second multiplexer selects to output the first input or the second input to the interpolation unit through the output terminal thereof according to the selecting signal.

3. The interpolation circuit as claimed in claim 2, wherein the second selecting channel comprises:
a third multiplexer having a plurality of input terminals and an output terminal, the input terminals of the third multiplexer receiving the second input group, and the output terminal of the third multiplexer being coupled to the second input terminal of the second multiplexer, wherein the third multiplexer outputs the second input through the output terminal thereof according to the selecting signal; and
a fourth multiplexer having a first input terminal, a second input terminal and an output terminal, the first input terminal of the fourth multiplexer being coupled to the output terminal of the first multiplexer and receiving the first input, the second input terminal of the fourth multiplexer being coupled to the output terminal of the third multiplexer and receiving the second input, and the output terminal of the fourth multiplexer being coupled to the interpolation unit, wherein the fourth multiplexer selects to output the first input or the second input to the interpolation unit through the output terminal thereof according to the selecting signal.

4. The interpolation circuit as claimed in claim 1, wherein the interpolation circuit receives N inputs, the first input group comprises N/2 inputs of the N inputs, wherein N is an even number.

5. The interpolation circuit as claimed in claim 4, wherein the first input group comprises (2n−1)^{th} inputs of the N inputs, wherein n is a positive integer smaller than or equal to N/2.

6. The interpolation circuit as claimed in claim 4, wherein the second input group comprises N/2 inputs of the N inputs.

7. The interpolation circuit as claimed in claim 6, wherein the second input group comprises 2n^{th} inputs of the N inputs.

8. The interpolation circuit as claimed in claim 1, wherein when the first selecting channel outputs the first input to the interpolation unit, the second selecting channel outputs the second input to the interpolation unit, and when the first selecting channel outputs the second input to the interpolation unit, the second selecting channel outputs the first input to the interpolation unit.
